(19) United States
(12) Patent Application Publication
(10) Pub. No.: US 2010/0156803 A1
(43) Pub. Date: Jun. 24, 2010

(54) Keyboard formed from touch display panel, method of imparting a keyboard input function to a touch display device, and device having a keyboard or hand-writing input function and an image output function

(76) Inventor: Chien-Chung Wu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/618,758

(22) Filed: Nov. 15, 2009

(30) Foreign Application Priority Data
Dec. 23, 2008 (TW) 097150299

(51) Int. Cl. G06F 3/02; G06F 3/041; G06F 3/033

(52) U.S. Cl. 345/172; 345/173; 345/163

(57) ABSTRACT

A keyboard layout image is displayed on a touch display, so as to serve as a keyboard to perform a key-in function corresponding to the keyboard layout image through touching the touch display. The keyboard layout image displayed on the touch display may be defined by an end user. Furthermore, a plurality of such touch displays may be connected in series to form a bigger keyboard with more defined key images. The keyboard formed from a touch display panel according to the present invention may be used in a device with a keyboard or writing pad input function and an image output function to replace a conventional keyboard or writing pad.

### BACKGROUND OF THE INVENTION

1. Field of the Invention

The present invention relates to a keyboard device, and particularly to a keyboard formed from a touch display panel, a method of imparting a keyboard input function to a touch display device, and a device having a keyboard or hand-writing input function and an image output function.

2. Description of the Prior Art

Conventionally, information storage or retrieve or communication with a computer is performed by means of an external keyboard or mouse. The function of input of a keyboard has been defined when the keyboard is produced, and users can not define them by themselves except only a few functional keys. Accordingly, it can not satisfy most people nowadays. There are a lot of innovative external models and ergonomic improvements for keyboards, but few variations with respect to the design of the keyboard structure per se. Furthermore, each key of the existing commercial keyboard is unalterably defined to a certain function with a constant symbol printed thereon. For example, marks “F1”, “F2”, “F3”, etc. are always printed on the functional keys F1, F2, F3, etc. Even users assign them for other functions respectively, the marks are still “F1”, “F2”, “F3”, etc., and users must deliberately remember the function of each key, for purpose of handiness.

With respect to conventional touch display devices, only a few simple icons may be provided on the display for users to press for input. Often, no additional picture or image is provided to be displayed simultaneously with these icons on the display. Therefore, the functions of the conventional touch display devices are limited.

Therefore, there is still a need for a novel product having a keyboard and/or mouse input function, and also an image output function, executed by a touch display panel or touch display panels.

### SUMMARY OF THE INVENTION

An objective of the present invention is to provide a keyboard formed from a touch display panel, a method of imparting a keyboard input function to a touch display device, and a device having a keyboard or hand-writing input function and an image output function, in which, users may define keys or connect a plurality of such keyboards in series to form a larger keyboard for having more key functions, as desired.

The keyboard formed from a touch display panel includes a touch display panel unit and a circuit board. The circuit board comprises a signal input/output device for signal input/output, a memory for storing a driving program and an operating program, and a microprocessor for executing the driving program to drive the touch display panel unit, executing the operating program to allow the touch display panel unit to display a keyboard layout image, and through the signal input/output device outputting a signal corresponding to the keyboard layout image in accordance with the position on the touch display panel unit being touched for a performance of a keyboard input function.

The method of imparting a keyboard input function to a touch display device includes steps as follows. A computer comprises a CPU (central processing unit) and a touch display device driving program is provided. At least a touch display device is provided to be connected with the computer and be driven. An operating program is executed using the CPU to define the at least a touch display device to display a keyboard layout image, thereby to execute a keyboard input function corresponding to the keyboard layout image in accordance with the position on the at least a touch display device being touched.

The device having a keyboard or hand-writing input function and an image output function includes a computer which comprises a CPU, a touch display device driving program, and a memory; a display device connected with the computer for displaying an image outputted from the computer; and at least a touch display device connected with the computer for serving the keyboard or hand-writing input function, wherein the touch display device displays a keyboard layout image defined by an operating program executed in the computer for executing a keyboard input function corresponding to the keyboard layout image being touched.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the method of imparting a keyboard input function to a touch display device according to the present invention;

FIG. 2 is a schematic diagram illustrating an embodiment of the keyboard formed from a touch display panel according to the present invention;

FIG. 3 is a schematic diagram illustrating an embodiment of switching between the keyboard function and the display function through a hot key in the present invention;

FIG. 4 is a schematic diagram illustrating an embodiment of an integrated keyboard formed by connecting a plurality of touch display devices in series in the present invention; and

FIG. 5 is a schematic diagram illustrating an embodiment of a keyboard layout image defined on the touch display panel of a touch display device by a user.

### DETAILED DESCRIPTION

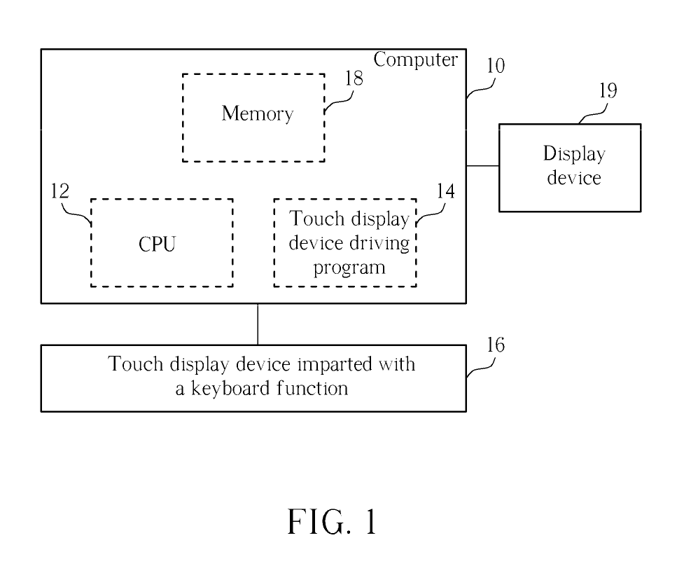

The keyboard formed from a touch display panel according to the present invention is a multi-input display device. FIG. 1 is a schematic diagram illustrating the method of imparting a keyboard input function to a touch display device according to the present invention. The method includes providing a computer 10. The computer 10 includes a CPU 12 and a touch screen driving program 14 stored in the computer 10. At least a touch display device 16 is also provided. The touch display device 16 connects with the computer 10 and is driven. An operating program is executed in the computer to define the touch display device 16 to display a keyboard layout image, such that when the keyboard layout image displayed by the touch display device 16 is touched, a signal corresponding to the keyboard layout image can be transmitted to the CPU 12 of the computer 10 to execute the keyboard input function corresponding to the keyboard layout image. The definition of the keyboard layout image on the touch display device may be stored in a memory 18, and it may be retrieved for use on demand. In the present invention, the touch display device 16 is imparted with a keyboard input function, and accordingly the computer system may need a display device 19 for displaying output images from the execution of ordinary programs in the computer; or an image display region may be further defined on the touch display device 16 for displaying output images from the execution of ordinary programs in the computer.

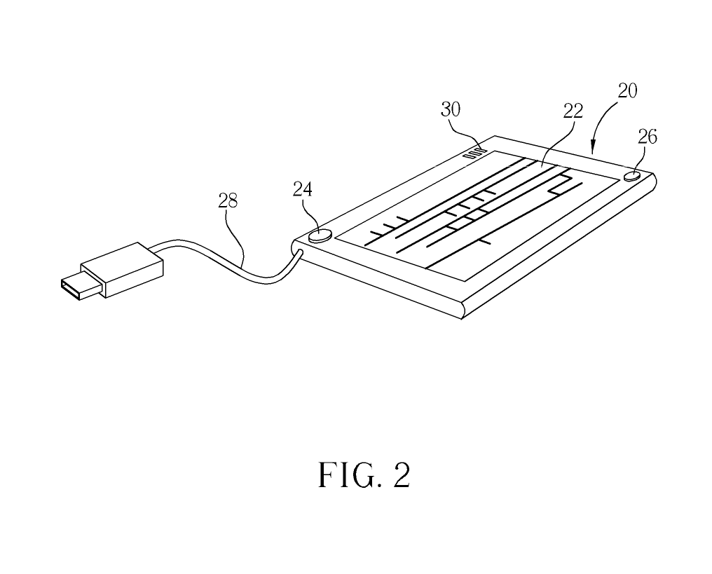

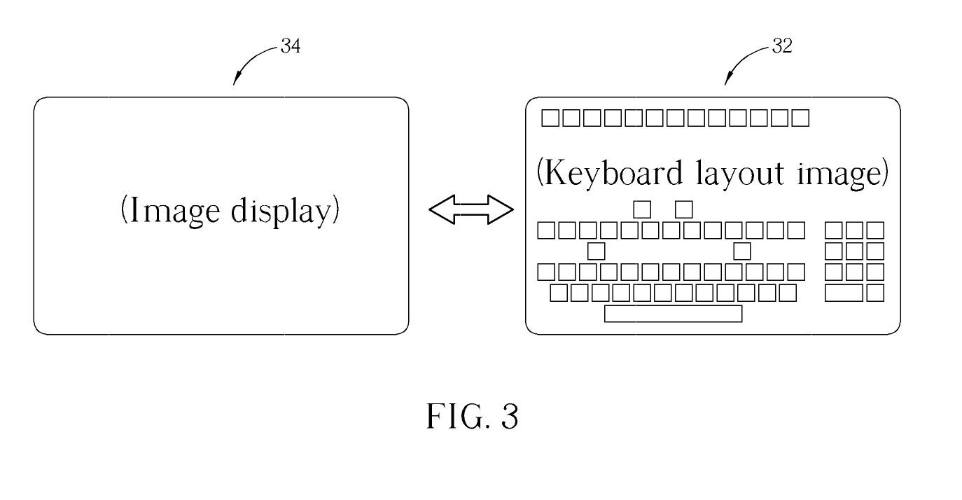

FIG. 2 is a schematic diagram illustrating an embodiment of the keyboard formed from a touch display panel according to the present invention. The touch display device 20 has a touch display panel 22 and may further have a power switch 24, a hot key 26, a cable 28, and a speaker 30. The touch display panel 22 may be a conventional touch display panel such as an optical, ultrasonic, infrared, resistive, or capacitive touch display panel, and the like, and may be multi-touch type, without particular limitations. The signal input/output may be accomplished by using the cable 28 to connect with the computer for input the signals to the computer. The transmission may be through RS232, USB, or wireless transmission, without particular limitations. One or more hot keys may be proposed as desired. FIG. 3 illustrates an embodiment of switching between the keyboard function 32 and the display function 34 through a hot key in the present invention.

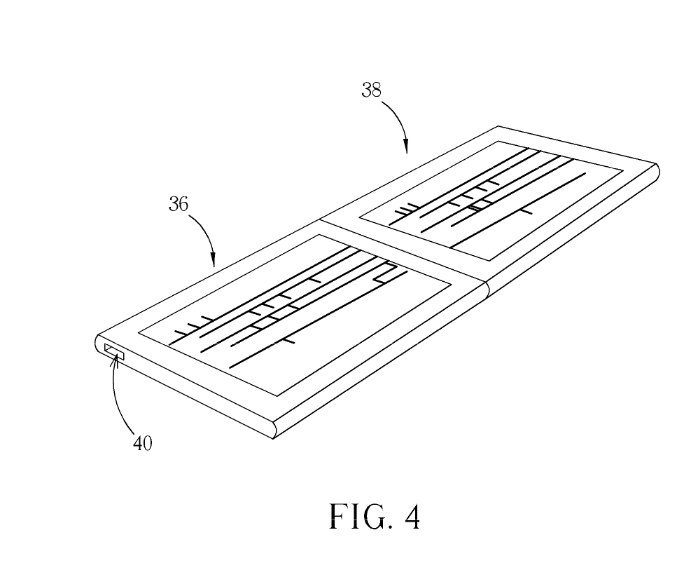

Furthermore, a plurality of touch display devices may be connected in series to form an integrated keyboard (working as a single keyboard) through definition by a program. For example, as shown in FIG. 4, the touch display devices 36, 38 each have a serial connecting device 40 at each of two sides and connect to each other in series. For example, wireless transmission, USB transmission, or the like may be utilized to accomplish the serial connection.

A feedback device, such as a device for key-pressing feeling or a sound device, may be further disposed in the touch display device. For example, the device for key-pressing feeling may be a vibration device to simulate the key-pressing feeling when a finger is touching the key image shown by the display. The vibration device may be accomplished by a micro-vibration or micro-electron flow mechanism of microelectromechanical systems (MEMS). Or, as soon as the computer receives an input signal from the keyboard formed from the touch display device, a speaker may give off a sound to simulate a key click sound for the touch.

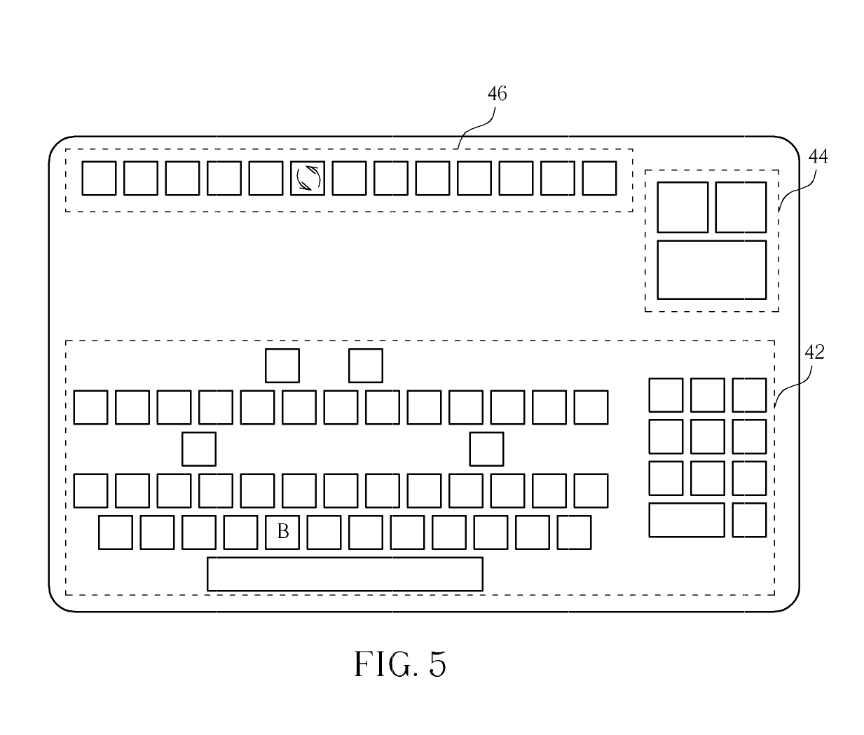

The operating program which is executed by the CPU may be written by utilizing, for example, a package program included in the operating system (such as VISTA) of Microsoft Company for screen division, a driving program for driving the touch display device, and the like. The operating program is used to arrange keys on the corresponding positions of the touch display device and may be stored in the memory. It allows users to define positions on the touch display panel to correspond to certain signals as desired, and the touch display device is allowed to display image patterns corresponding to the certain signals. For example, as shown in FIG. 5, a keyboard layout image, such as a conventional keyboard layout image, defined by a user is schematically shown in the keyboard region 42 of the display panel of the touch display device, and a function corresponding to the image will be executed in accordance with the position of the image being touched. For example, when the position for the image pattern, letter “B”, is touched, a signal or signals corresponding to “B” are generated and outputted for transmission to the computer for serving a function as equivalent as a keyboard.

In addition to the definition of the image of the conventional keyboard as shown in FIG. 5, an image for mouse function may be further defined on the touch display device, as shown by the mouse region 44 in FIG. 5. Additionally, in the function key region 46, certain images may be given to the position representing certain function keys for helping users to know the functions of the function keys. For example, the position of the function key “F5” may be made to display a word pattern “rearrangement” or an image pattern having the same meaning, such that a user will easily know to touch the position for executing the function of rearranging web page as soon as casting a glance at the pattern without deliberate memorization of the function for “F5”.

As described above, users may define keyboard by themselves as desired. For example, users from different countries may define a keyboard displaying their mother language for each key with the key images together. Conventional keyboard needs to be printed with a country language letters or characters according to the country where the keyboard is sold. The definition of keyboard of the present invention is also modifiable by users as desired. Furthermore, a hot key may be defined to represent multiple keys or a set of keys. A special key can be also defined. For example, such special key may be a small pattern shown on the display to be defined as an application program in execution, and when the small pattern on the display is touched in the keyboard function mode, users may conveniently switch to the application program.

For music keyboard users, a plurality of the touch display devices may be further connected in series to form an integrated keyboard (which may be long) to define complicated music keys such as keys for musical scales, accompaniments, sound effects, and the like for variant instruments. It may be like to form an electronic musical instrument, synthesizer or musical workstation, which keys can be arranged by users without being limited to a commercial fixed arrangement.

In another aspect of the present invention, a circuit board may be disposed in a touch display device, such that the touch display device may be turned on to serve as a keyboard even being off-line from the computer. Accordingly, the touch display device includes, in addition to a touch display panel unit and a signal input/output device for signal input/output, a memory for storing a driving program and an operating program, and a microprocessor for executing the driving program to drive the touch display panel unit, executing the operating program to allow the touch display panel unit to display a keyboard layout image, and through the signal input/output device outputting a signal corresponding to the keyboard layout image in accordance with the position on the touch display panel unit being touched. The circuit board may be disposed within the frame of the touch display device. When the touch display panel unit requires a backlight module, the driving circuit for the backlight module may be integrated with the aforesaid circuit board for providing a working voltage to the backlight. Variant keyboard functions on the touch display panel unit may be defined by program execution in the microprocessor. The memory may be a built-in or removable memory card, such as a Compact Flash (CF), a flash memory card, a Memory Stick (MS), a Smart Media (SM), a Secured Digital (SD), and the like. Accordingly, users can conveniently carry the touch display device with their own definition as a keyboard to other computer systems for use. Such keyboard formed from the touch display panel is very suitably used in products built with a keyboard or hand-writing input function and an image output function for replacing conventional keyboard or hand-writing input device.

As compared with conventional techniques, the present invention has advantages described as follows:
1. With the touch display panel serving as a keyboard, it is possible for a user to alter the layout and the function of the keyboard as desired with the assist of the operation software to improve the variety for the keyboard input;
2. Such keyboard may be with both a function of keyboard and a function of mouse since the keyboard region and the mouse region can be defined simultaneously on the display;
3. The keyboard may become a second display device by touching the hot key, and the image display region can be also defined such that both of the keyboard and the display screen can exist in the same time; accordingly, such keyboard is also a display screen;
4. A plurality of such keyboards can be used by connecting them in series through a serial connecting device of each keyboard, and the definition for the keyboard can be altered and even two or more different sets of definitions for the keyboard can be made as desired through the software; and
5. To increase on-the -spot feeling, sound effects may be established using software and, through a speaker, allow users to feel like a key click sound.

Those skilled in the art will readily observe that numerous modifications and alterations of the device and method may be made while retaining the teachings of the invention.

What is claimed is:

1. A keyboard formed from a touch display panel comprising:
a touch display panel unit; and
a circuit board comprising:
a signal input/output device for signal input/output,
a memory for storing a driving program and an operating program, and
a microprocessor for executing the driving program to drive the touch display panel unit, executing the operating program to allow the touch display panel unit to display a keyboard layout image, and through the signal input/output device outputting a signal corresponding to the keyboard layout image in accordance with the position on the touch display panel unit being touched for a performance of a keyboard input function.

2. The keyboard formed from a touch display panel of claim 1, further comprising a serial connecting device for connecting another keyboard formed from a touch display panel in series.

3. The keyboard formed from a touch display panel of claim 1, further comprising a hot key for switching the touch display device unit to serve between the keyboard input function and a display function.

4. The keyboard formed from a touch display panel of claim 1, wherein, the microprocessor executes the operating program for allowing the touch display panel unit to further display an image for mouse function, and through the signal input/output device outputting a signal corresponding to the image for mouse function in accordance with the position on the touch display panel unit being touched.

5. The keyboard formed from a touch display panel of claim 1, further comprising a device providing a key-pressing feeling.

6. The keyboard formed from a touch display panel of claim 1, wherein the microprocessor executes the operating program for allowing the touch display panel unit to further display a user-defined image, and through the signal input/output device outputting a signal corresponding to the user-defined image in accordance with the position on the touch display panel unit being touched.

7. The keyboard formed from a touch display panel of claim 1, further comprising a speaker for giving a key-click sound corresponding to each touch on the touch display panel unit.

8. The keyboard formed from a touch display panel of claim 1, wherein the touch display panel unit further comprises an image display region for displaying an input image.

9. The keyboard formed from a touch display panel of claim 1, wherein the memory stores at least a result of executing the operating program.

10. A method of imparting a keyboard input function to a touch display device comprising:
providing a computer comprising:
a CPU, and
a touch display device driving program;
providing at least a touch display device connected with the computer and driven; and
executing an operating program using the CPU to define the at least a touch display device to display a keyboard layout image, thereby to execute a keyboard input function corresponding to the keyboard layout image in accordance with the position on the at least a touch display device being touched.

11. The method of claim 10, wherein, a plurality of the touch display devices are further provided, and all of the touch display devices are connected in series to form an integrated keyboard.

12. The method of claim 10, further comprising defining the at least a touch display device to display an image for mouse function, thereby to execute the mouse input function in accordance with the position of the image for mouse function being touched.

13. The method of claim 10, further comprising disposing a device for simulating a key-pressing feeling on the at least a touch display device.

14. The method of claim 10, further comprising allowing the computer to receive an input signal from the at least a touch display device and give off sound for the touch.

15. The method of claim 10, further comprising disposing a hot key on the at least a touch display device for switching the at least a touch display device to serve between an image display function and the keyboard input function.

16. The method of claim 10, further comprising storing a definition of the keyboard layout image of the at least a touch display device in the memory for retrieve on demand.

17. The method of claim 10, further comprising defining a user-defined image on the at least a touch display device for executing a function corresponding to the user-defined image upon touching the user-defined image.

18. The method of claim 10, further comprising defining an image display region on the at least a touch display device for displaying an input image.

19. A device having a keyboard or hand-writing input function and an image output function, comprising:
a computer comprising:
a CPU,
a touch display device driving program, and
a memory;
a display device connected with the computer for displaying an image outputted from the computer; and
at least a touch display device connected with the computer for serving the keyboard or hand-writing input function, wherein the touch display device displays a keyboard layout image defined by an operating program executed in the computer for executing a keyboard input function corresponding to the keyboard layout image being touched.

20. The device of claim 19, wherein the device comprises a plurality of the touch display devices and all of the touch display devices are connected in series to form an integrated keyboard.

21. The device of claim 19, wherein the touch display device further display an image for mouse function, such that a mouse input function is executed by touching the image for mouse function.

22. The device of claim 19, wherein the touch display device comprises a device for simulating a key-pressing feeling.

23. The device of claim 19, wherein the computer receives an input signal from the touch display device and gives off sound for the touch.

24. The device of claim 19, wherein the touch display device comprises a hot key for switching the touch display device to serve between an image display function and the keyboard input function.

25. The device of claim 19, wherein there are a plurality of keyboard layout image definitions for the touch display device and each of the keyboard layout image definitions is stored in the memory for retrieve on demand.

26. The device of claim 19, wherein the touch display device further displays a user-defined image for executing a user-defined function by touching the user-defined image.

27. The device of claim 19, wherein the touch display device further comprises an image display region for displaying an input image.
